(19) United States
(12) Patent Application Publication
(10) Pub. No.: US 2009/0299844 A1
(43) Pub. Date: Dec. 3, 2009

(54) PREPAID RELOADABLE ELECTRONIC TRANSACTION CARDS WITH LOYALTY PROGRAM

(75) Inventors: Clare Reilly, Cincinnati, OH (US); David McCreadie, Terrace Park, OH (US)

Correspondence Address: BARLOW, JOSEPHS & HOLMES, LTD., 101 DYER STREET, 5TH FLOOR, PROVIDENCE, RI, 02903, US

(73) Assignee: KROGER PERSONAL FINANCE, Cincinnati, OH (US)

(21) Appl. No.: 12/474,424

(22) Filed: May 29, 2009

Related U.S. Application Data
(60) Provisional application No. 61/056,846, filed on May 29, 2008.

(51) Int. Cl. G06Q 30/00; G06K 19/00; G06Q 40/00; G06Q 50/00

(52) U.S. Cl. 705/14.27; 235/487; 705/14.34; 705/30; 705/41

(57) ABSTRACT

A reloadable prepaid electronic transaction card is provided that is tied either electronically or physically with a loyalty program, a bonus point program or reward program. The card includes machine readable indicia thereon that allows the card to be linked with a cash balance that resides on the card itself or in an account that is tied to the card. Another feature of the transaction card is that it is tied either electronically or physically to a loyalty program. In one embodiment the card is a reloadable prepaid electronic transaction card that both allows the customer to complete a purchase transaction without the need for cash while also including a customer loyalty code. In another embodiment, the card is tied to a points or bonus rewards system. In a further embodiment, the reloadable prepaid electronic transaction card is used to provide rebates for purchases, such as fuel purchases.

### CROSS-REFERENCE TO RELATED APPLICATIONS

This application is related to and claims priority from earlier filed U.S. Provisional Patent Application No. 61/058,846, filed May 29, 2008.

### BACKGROUND OF THE INVENTION

The present invention relates generally to a reloadable prepaid electronic transaction card that is tied together with a customer loyalty or rewards program. More specifically, the present invention relates to a reloadable prepaid electronic transaction card that is tied either electronically or physically with a loyalty reward program in a manner that provides a customer with points or discounts based on usage or reloading of the electronic transaction card.

Recently, there has been a large growth in the use of electronic transaction cards such as credit cards and debit cards to make purchases. When using such cards, the transaction involves the electronic transfer of funds from the cardholder's account to an account held by the seller of the goods or services. The structure of this transaction can be appreciated to be the same whether the electronic transaction is a gift card, a prepaid goods/services card, a credit card or a debit card. Regardless of the format of the card, a purchase transaction for a product over the Internet may involve the electronic submission of a credit card number, an electronic communication to the credit card issuer for authorization of a total purchase price and an electronic debiting of the customer's account when the purchase process is completed. Similarly, the use of such a card to obtain cash from an automatic teller machine (ATM) also involves the equivalent of an electronic transfer of funds as described above, except that rather than crediting the seller's account, cash is dispensed to the cardholder. Still further, credit card purchases serve to transfer money from a line of credit established for the benefit of the consumer wherein the consumer has agreed to repay the line of credit at a later date. Generally, the use of electronic commerce in this manner benefits consumers and businesses in terms of convenience, security, and accounting.

One difficulty that arises from the use of electronic commerce as described above however, is that the majority of present day electronic commerce activities require that a consumer have at least an established bank account and usually one or more credit card accounts. As a result, there are many people that cannot take advantage of the available electronic commerce system because they do not have the necessary established bank or credit card accounts (e.g. unbanked/under banked customers). Accordingly, while electronic transactions constitute a considerable percentage of current commercial transactions, the benefits of electronic commerce could be expanded to a much greater degree through the development of new methods and systems.

To overcome the above noted problem, many of the unbanked customers generally carry out financial transactions through the use of cash, money orders, stored value cards or similar vehicles, all of which do not require a bank to complete the transaction. While this method works for the sole purpose of completing a transaction, both the customer and the reseller are missing an opportunity for cross-promotion that is inherent in many of the electronic transaction vehicles described above. For example, many credit cards provide the cardholder with rebates and/or cash back on the purchases made using their card. Unbanked customers simply are not presented with this opportunity. Similarly, many retail locations offer loyalty cards to customers for use in obtaining points or special promotional offers that are only available to loyalty cardholders. In these cases, such opportunities are lost to customers who cannot or will not use the loyalty cards.

There is therefore a need for a prepaid electronic transaction card that is tied with a loyalty program. There is a further need for a reloadable prepaid electronic transaction card that is tied either electronically or physically with a loyalty reward program. There is still a further need for a reloadable prepaid electronic transaction card that provides access to loyalty rebates and rewards programs for unbanked customers.

### BRIEF SUMMARY OF THE INVENTION

In this regard, the present invention provides a reloadable prepaid electronic transaction card that is tied with a loyalty program. In general, the present invention provides a reloadable prepaid electronic transaction card that is tied either electronically or physically with a loyalty reward program. The reloadable prepaid electronic transaction card is of the same type as is typically known in the art. The card includes machine readable indicia thereon that allows the card to be linked with a cash balance that resides on the card itself or in an account that is tied to the card. Such a cash balance may itself be recorded on the card in the form of a magnetic strip or may be recorded in an account to which access is gained via a code on a magnetic strip or a code that is readable via an optical scanner.

In operation, the user selects the card that they desire, they pay a sum of money to a cashier and the cashier in turn credits a value onto the card that is equivalent to the sum of money originally paid, often less the card purchase fee. In addition, the card can be periodically reloaded in the same manner in which it was originally activated wherein a sum of money is paid to a cashier and that sum of money is credited to the electronic transaction card, often less a reload fee. As is known in the art, such cards allow previously unbanked customers access to services that were previously unavailable or inconvenient to access.

Another feature of the reloadable prepaid electronic transaction card is that it is tied either electronically or physically to a loyalty program. Preferably, in addition to including a machine readable element by which the customer accesses the funds credited onto the card, the card also includes a readable code in the form of a customer loyalty code. It is of note to one skilled in the art that the present invention may take a variety of forms and while several illustrative embodiments are provided herein they are meant as examples and are not intended to limit the scope of the invention to any one embodiment. In one embodiment the card may be a reloadable prepaid electronic transaction card that both allows the customer to complete a purchase transaction without the need for cash while also including a customer loyalty code that allows them to get the point of sale discounts, coupons or rewards associated with the use of the loyalty code. In another embodiment, in addition to the traditional reloadable prepaid electronic transaction card functionality, the card is tied to a points or bonus rewards system. In a further embodiment, the reloadable prepaid electronic transaction card may be used to provide rebates to a customer for purchases that are made using the card, such as fuel purchases for example.

Accordingly, it is an object of the present invention to provide a prepaid electronic transaction card that is tied with a loyalty program. It is a further object of the present invention to provide a reloadable prepaid electronic transaction card that is tied either electronically or physically with a loyalty reward program. It is still a further object of the present invention to provide a reloadable prepaid electronic transaction card that provides access to loyalty rebates and rewards programs for unbanked customers.

These together with other objects of the invention, along with various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a front perspective view of an electronic transaction card bundle in accordance with the present invention;

FIG. 2 is a flow chart describing the operation of a first embodiment of the present invention;

FIG. 3 is a flow chart describing the operation of a second embodiment of the present invention;

FIG. 4 is a flow chart describing the operation of a third embodiment of the present invention; and

FIG. 5 is a flow chart describing the operation of a third embodiment of the present invention.

### DETAILED DESCRIPTION OF THE INVENTION

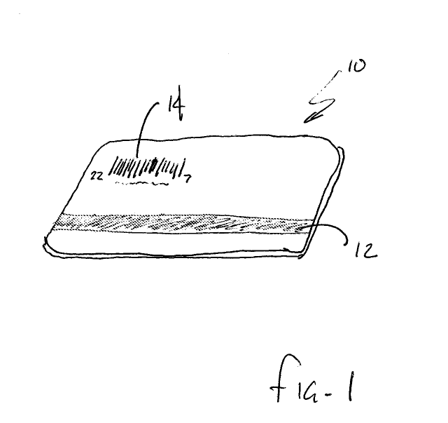

Now referring to the drawings, a reloadable prepaid electronic transaction card that is tied with a loyalty program as disclosed in the present invention is shown and generally illustrated in the figures. In the most general embodiment as shown at FIG. 1, the present invention provides a reloadable prepaid electronic transaction card 10 that is tied either electronically or physically with a loyalty reward program. In further embodiments, prepaid electronic transaction card of the present invention the card is a reloadable prepaid electronic transaction card that both allows the customer to complete a purchase transaction without the need for cash while also including a customer loyalty code that allows then to get the point of sale discounts, coupons or rewards associated with the use of the loyalty code. In another embodiment, in addition to the traditional reloadable prepaid electronic transaction card functionality, the card is tied to a points or bonus rewards system. In still a further embodiment, the reloadable prepaid electronic transaction card is used to provide rebates to a customer for purchases that are made using the card, such as fuel purchases for example.

In general, turning to FIG. 1, the present invention provides a reloadable prepaid electronic transaction card 10 that is tied either electronically or physically with a loyalty reward program. The reloadable prepaid electronic transaction card 10 is of the same type as is typically known in the art. The card includes at least one set of machine readable indicia 12 thereon that allows the transaction card 10 to be linked with a cash balance that resides on the transaction card 10 itself or in an account that is tied to the transaction card 10. Such a cash balance may itself be recorded on the transaction card 10 in machine readable indicia the form of a magnetic strip 12 or may be recorded in an account to which access is gained via a code on a magnetic strip 12 or a code that is readable via an optical scanner 14. Still further, it is preferable that the transaction card 10 includes first machine readable indicia 12 thereon relating to the available fund balance the transaction card and second machine readable indicia 14 thereon relating to a loyalty reward program tied to the usage of the transaction card 10. It should be appreciated by one skilled in the art that while reference is made to first and second machine readable indicia 12, 14, such indicia may combined into a single code or magnetic strip on the transaction card 10 or may be provided as separate codes or magnetic strips.

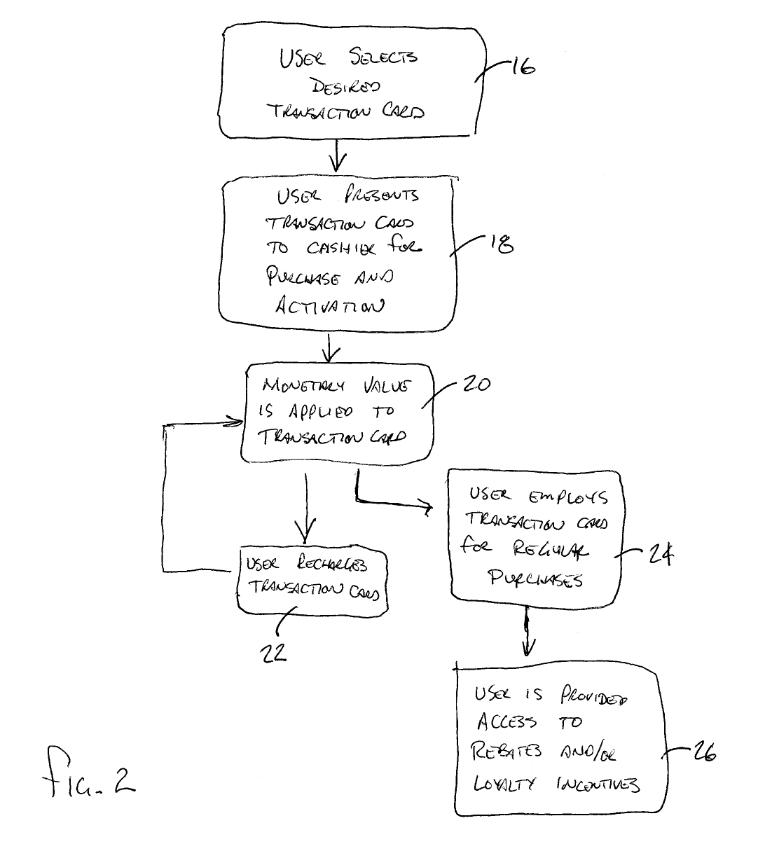

As can be seen at FIG. 2, in operation the user selects 16 the transaction card that they desire, they pay a sum of money to a cashier 18 and the cashier in turn credits a value onto the transaction card 20 that is equivalent to the sum of money originally paid, often less the transaction card purchase fee. In addition, the transaction card can be periodically reloaded 22 in the same manner in which it was originally activated wherein a sum of money is paid to a cashier 20 and that sum of money is credited to the electronic transaction card, often less a reload fee. Further, the customer can then use the electronic transaction card as a payment device for conducting purchases in a normal fashion 24 as is already known in the art. In this manner, such transaction cards allow previously unbanked customers access to services that were previously unavailable or inconvenient to access.

Another feature of the reloadable prepaid electronic transaction card 10 is that it is tied either electronically or physically to a loyalty program. Preferably, in addition to including a machine readable element by which the customer accesses the funds credited onto the transaction card, the transaction card also includes a readable code in the form of a customer loyalty code. As such, a customer using the transaction card is provided access to rebates and/or loyalty incentives 26 that are tied to usage of the transaction card 10. It is of note to one skilled in the art that the present invention may take a variety of forms and while several illustrative embodiments are provided herein they are meant as examples and are not intended to limit the scope of the invention to any one embodiment.

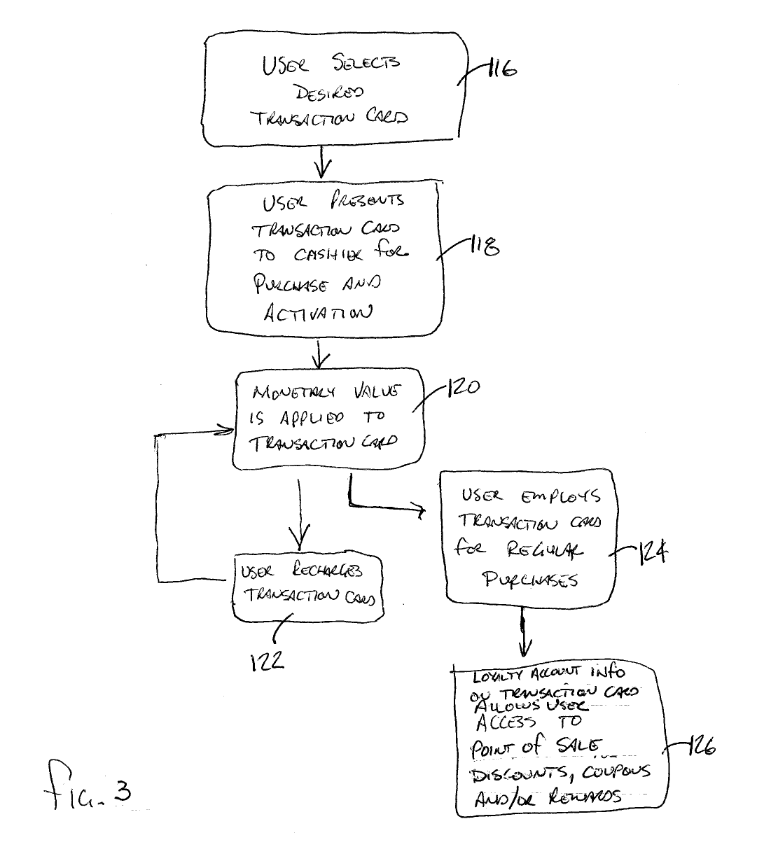

In a one embodiment, the operation of which is illustrated at FIG. 3, most supermarkets issue loyalty cards to their returning customers that allow those customers the ability to obtain promotional specials, coupons and discounts that are awarded only to loyal customers based on repeated usage of their loyalty code. Instead of issuing a separate loyalty card, a customer selects a reloadable prepaid electronic transaction card 116 and presents the transaction card for purchase 118 wherein after payment is made to the cashier monetary value is applied to the transaction card 120. Further, as was provided above, the user can periodically recharge the transaction card 122 as necessary. The electronic transaction card in turn allows the customer to complete their regular purchase transaction 124 without the need for cash while. Further, the inclusion of a loyalty account code in the transaction card also allows the customer to use the loyalty code on their transaction card to get the point of sale discounts, coupons or rewards associated with the use of the loyalty code 126. As was provided in connection with FIG. 1, such a loyalty code may appear on the transaction card 10 as a separate readable code on the transaction card 10 or it may be electronically coded on the transaction card such that it is read when the electronic transaction takes place.

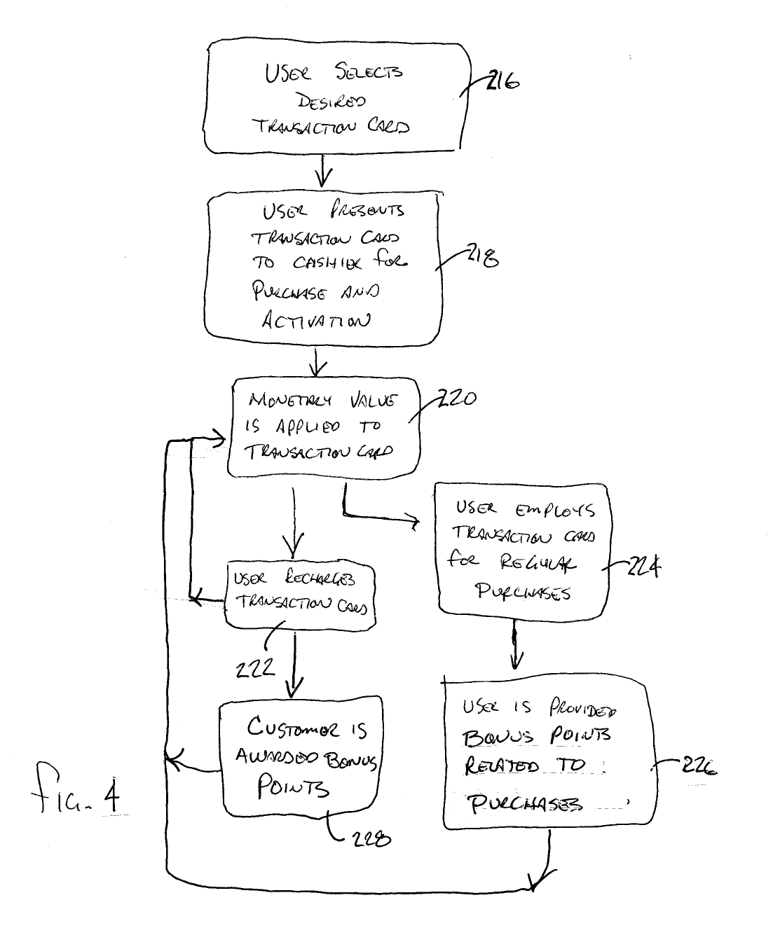

In another embodiment, the operation of which is illustrated at FIG. 4, in addition to the traditional reloadable prepaid electronic transaction card functionality, the transaction card is tied to a points or bonus rewards system. In operation, a customer selects a reloadable prepaid electronic transaction card 216 and presents the transaction card for purchase 218 wherein after payment is made to the cashier monetary value is applied to the transaction card 220. Further, as was provided above, the user can periodically recharge the transaction card 222 as necessary. The electronic transaction card in turn allows the customer to complete their regular purchase transaction 224 without the need for cash. Each time the transaction card is reloaded 222, the customer is awarded bonus points or a reward of some type 228. The reward or bonus points may be tied to the amount of credit applied to the reloadable prepaid electronic transaction card or may simply be tied to the act of reloading the transaction card. In this embodiment for example, such a transaction card may be issued for use in connection with the purchase of music downloads. Accordingly, each time the customer reloads 222 the transaction card with a threshold amount, the customer may be awarded a credit for a free download 228. Similarly, each time a customer reloads 222 the transaction card, points may be accumulated that can then be redeemed for additional merchandise or converted to cash. Further, it may be provided that each time a customer uses the transaction card to make a purchase 226, points may be accumulated that can then be redeemed for additional merchandise or converted to cash.

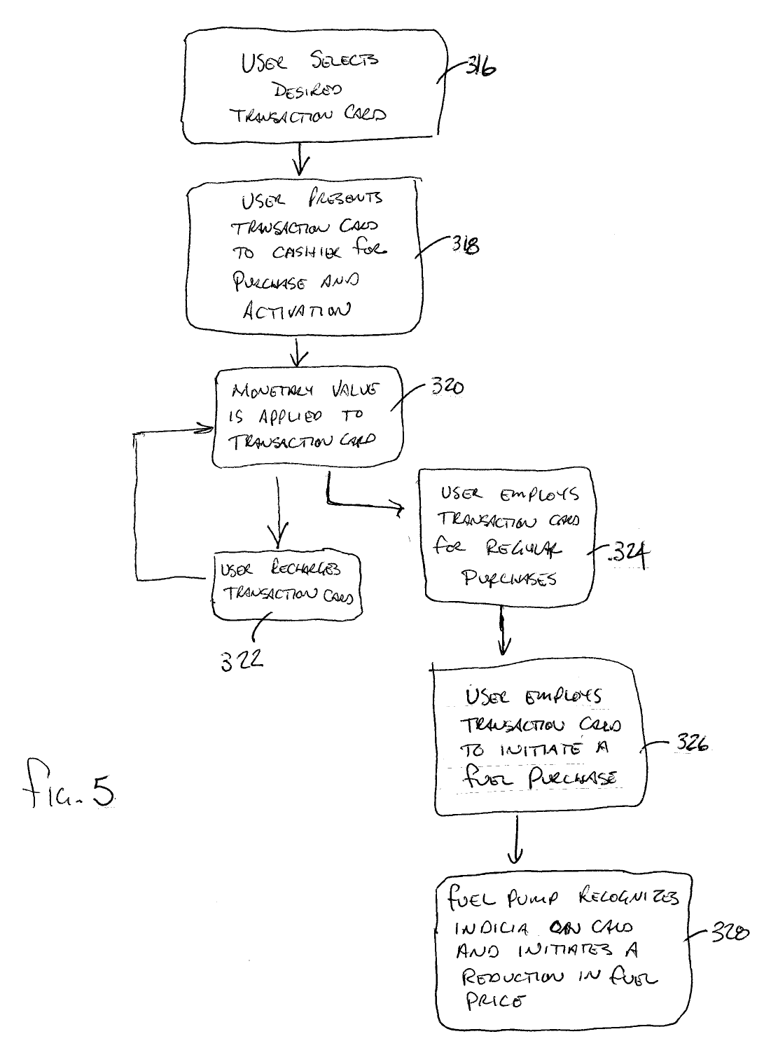

In still a further embodiment, the operation of which is illustrated at FIG. 5, the reloadable prepaid electronic transaction card may be used to provide rebates to a customer for fuel purchases. In operation, a customer selects a reloadable prepaid electronic transaction card 316 and presents the transaction card for purchase 318 wherein after payment is made to the cashier monetary value is applied to the transaction card 320. Further, as was provided above, the user can periodically recharge the transaction card 322 as necessary. The electronic transaction card in turn allows the customer to complete their regular purchase transaction 324 without the need for cash. In a preferred version of this embodiment of the present invention, a reloadable prepaid electronic transaction card is provided that is recognized at the gas pump of a preferred provider. When a customer initiates a purchase at such a pump 326, the fuel price is automatically reduced by the rebate amount on the pump itself 328. In this regard, the customer is provided with their rebate immediately at the point of sale. In operation for example, the price of gasoline at the pump on a given day may be listed at $3.79 per gallon. When the customer initiates the transaction using the reloadable prepaid electronic transaction card of the present invention, the listed price per gallon is reduced by the rebate amount. Should the rebate be $0.15 per gallon, the price at the pump is automatically rolled back to $3.64 for the duration of that fuel purchase. Once the transaction is complete, the pump then returns to the original listed price of $3.79 per gallon. In this manner the customer gets the immediate benefit of the reward.

Accordingly, it can be seen that the present invention provides a prepaid electronic transaction card that is tied either electronically or physically with a loyalty reward program in a manner that allows access to loyalty rebates and rewards programs for unbanked customers. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A prepaid electronic transaction card comprising:
a transaction card;
first machine readable indicia on said transaction card relating to the available fund balance for said transaction card; and
second machine readable indicia on said transaction card relating to a loyalty reward program tied to usage of said transaction card.

2. The prepaid electronic transaction card of claim 1, wherein said transaction card has a cash value, the balance of said cash value being recorded in said first machine readable indicia.

3. The prepaid electronic transaction card of claim 1, wherein said transaction card is linked to an account, the account information being recorded in said first machine readable indicia.

4. The prepaid electronic transaction card of claim 1, wherein a value of said loyalty reward program is recorded in said second machine readable indicia.

5. The prepaid electronic transaction card of claim 1, wherein a value of said loyalty reward program is recorded in an account, the account information being recorded in said second machine readable indicia.

6. The prepaid electronic transaction card of claim 1, wherein said first and second machine readable indicia are combined in a single code or magnetic strip.

7. The prepaid electronic transaction card of claim 1, wherein said first and second machine readable indicia are provided in separate codes or magnetic strips.

8. The prepaid electronic transaction card of claim 1, wherein said first and second machine readable indicia are recorded in a magnetic strip or a code that is readable via an optical scanner.

9. The prepaid electronic transaction card of claim 1, wherein said second machine readable indicia is a loyalty program account number.

10. The prepaid electronic transaction card of claim 9, wherein said loyalty program account number is offered in connection with a supermarket.

11. The prepaid electronic transaction card of claim 9, wherein said loyalty program account number allows a user to obtain promotional specials, coupons and discounts.

12. The prepaid electronic transaction card of claim 1, wherein said second machine readable indicia is a bonus point account.

13. The prepaid electronic transaction card of claim 12, wherein a user accumulates bonus points in said bonus point account for each use of said transaction card.

14. The prepaid electronic transaction card of claim 12, wherein a user accumulates bonus points in said bonus point account each time said user reloads said transaction card.

15. The prepaid electronic transaction card of claim 1, wherein said second machine readable indicia is a rewards account.

16. The prepaid electronic transaction card of claim 15, wherein a user accumulates rewards in said rewards account for each use of said transaction card.

17. The prepaid electronic transaction card of claim 15, wherein a user accumulates rewards in said rewards account each time said user reloads said transaction card.

18. The prepaid electronic transaction card of claim 1, wherein said second machine readable indicia is operable to provide a user with rebates for fuel purchases.

19. The prepaid electronic transaction card of claim 18, wherein said user accumulates rebates in a rebate account for each use of said transaction card.

20. The prepaid electronic transaction card of claim 18, wherein a fuel pump reads said second machine readable indicia and adjusts a price of the fuel offered at said fuel pump by a rebate amount.

21. The prepaid electronic transaction card of claim 20, wherein said rebate amount is deducted from the overall purchase price.

22. The prepaid electronic transaction card of claim 20, wherein said rebate amount is deducted from the incremental price per unit of fuel.
